(19) United States
(12) Patent Application Publication
(10) Pub. No.: US 2026/0274241 A1
(43) Pub. Date: Sep. 17, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Toyota-shi (JP); DENSO CORPORATION, Kariya-city (JP)

(72) Inventors: Hirotada OTAKE, Susono-shi (JP); Hideki KAMATANI, Toyota-shi (JP); Hiroki TERASHITA, Susono-shi (JP)

(73) Assignees: TOYOTA JIDOSHA KABUSHIKI KAISHA, Toyota-shi (JP); DENSO CORPORATION, Kariya-city (JP)

(21) Appl. No.: 19/454,789

(22) Filed: Jan. 21, 2026

(30) Foreign Application Priority Data
Mar. 11, 2025 (JP) 2025-038207

(51) Int. Cl. B60W 20/10; B60W 10/06; B60W 10/08; B60W 30/18; B60W 60/00

(52) U.S. Cl. CPC B60W 20/10; B60W 10/06; B60W 10/08; B60W 30/18072; B60W 60/001; B60W 2510/244; B60W 2554/404; B60W 2554/802

(57) ABSTRACT

A vehicle driving assistance apparatus does not execute an intermittent driving control of driving a host vehicle by autonomously and alternately executing a propelling control and a coasting control when a prohibition condition is satisfied in a situation where the intermittent driving control is requested. The prohibition condition is satisfied when one of a condition that a stored electric power amount is equal to or smaller than a predetermined amount, a condition that a stored electric power consumption rate is equal to or greater than a predetermined rate, a condition that a host vehicle speed is equal to or smaller than a predetermined speed, a condition that a following vehicle cannot be detected, and a condition that a driving apparatus is operated in a mode in which a state in which only motor mechanical power is used without using engine mechanical power for driving the host vehicle occurs is satisfied.

### CROSS-REFERENCE TO RELATED APPLICATIONS

This application claims priority to Japanese patent application No. JP 2025-038207 filed on Mar. 11, 2025, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus which executes an intermittent driving control of driving a host vehicle by autonomously and alternately executing a propelling control of propelling the host vehicle and a coasting control of causing the host vehicle to coast. In addition, as such a vehicle driving assistance apparatus, there is also known a vehicle driving assistance apparatus in which, when a following vehicle exists near the host vehicle, a timing for switching between the propelling control and the coasting control is made earlier so as to make a change in a traveling speed of the host vehicle smaller (for example, refer to Japanese Unexamined Patent Publication No. 2024-108500). As a result, the conventional vehicle driving assistance apparatus suppresses the host vehicle from becoming an obstacle to the traveling of the following vehicle due to the execution of the intermittent driving control.

Even if the timing for switching between the propelling control and the coasting control is made earlier in a situation where a following vehicle exists near the host vehicle as in the conventional vehicle driving assistance apparatus, there is a possibility that the host vehicle becomes an obstacle to the traveling of the following vehicle. Therefore, it can be said that it is not preferable to execute the intermittent driving control in a situation where a following vehicle exists near the host vehicle. In addition, there are scenes other than the scene where the following vehicle exists near the host vehicle in which it is not preferable to execute the intermittent driving control. Therefore, it is desirable to specify a scene in which the execution of the intermittent driving control is not preferable, and to prohibit the execution of the intermittent driving control in such a scene.

### SUMMARY

An object of the present invention is to provide a vehicle driving assistance apparatus, a vehicle driving assistance method, and a storage medium storing a vehicle driving assistance program capable of effectively prohibiting the execution of the intermittent driving control.

A vehicle driving assistance apparatus comprises an electronic control unit which executes an intermittent driving control of driving a host vehicle by autonomously and alternately executing a propelling control of propelling the host vehicle and a coasting control of causing the host vehicle to coast. A driving apparatus which generates mechanical power and a battery which stores electric power are mounted on the host vehicle. The driving apparatus includes an internal combustion engine and a motor generator. The motor generator operates by electric power supplied from the battery to generate mechanical power and also operates by mechanical power generated by the internal combustion engine to generate electric power. Electric power generated by the motor generator is stored in the battery. The propelling control is a control of propelling the host vehicle by mechanical power generated by the internal combustion engine and/or the motor generator. The electronic control unit is configured not to execute the intermittent driving control when a prohibition condition is satisfied in a situation where execution of the intermittent driving control is requested. The prohibition condition is satisfied when at least one of the following is satisfied: a first condition that an amount of electric power stored in the battery is equal to or smaller than a predetermined prohibition stored electric amount; a second condition that a consumption rate of electric power stored in the battery is equal to or greater than a predetermined prohibition consumption rate; a third condition that a traveling speed of the host vehicle is equal to or smaller than a predetermined prohibition speed; a fourth condition that the electronic control unit cannot detect a following vehicle; and a fifth condition that the driving apparatus is operated in an operation mode in which an electric drive traveling state in which only mechanical power generated by the motor generator is used without using mechanical power generated by the internal combustion engine as mechanical power for driving the host vehicle occurs.

When the amount of electric power stored in the battery becomes small, it becomes necessary to input mechanical power generated by the internal combustion engine to the motor generator to charge the battery. In addition, when an electric load such as a heating device is operating, the consumption rate of the electric power stored in the battery becomes high. Therefore, there is a possibility that the necessity to input the mechanical power generated by the internal combustion engine to the motor generator to charge the battery arises earlier. At this time, when the host vehicle is coasting by the coasting control, the operation of the internal combustion engine has been stopped. Therefore, the internal combustion engine is started. However, while the coasting control is executed, the mechanical power generated by the internal combustion engine is not used for driving the host vehicle but is used exclusively for generating electric power by the motor generator. As a result, the energy efficiency of the internal combustion engine becomes low.

According to the vehicle driving assistance apparatus of the present invention, when the amount of electric power stored in the battery is equal to or smaller than the predetermined prohibition stored electric amount, the intermittent driving control is not executed. In addition, according to the vehicle driving assistance apparatus of the present invention, when the consumption rate of the electric power stored in the battery is equal to or greater than the predetermined prohibition consumption rate, the intermittent driving control is not executed. Therefore, the execution of the intermittent driving control can be effectively prohibited.

In addition, when the coasting control is executed while the traveling speed of the host vehicle is relatively low, there is a possibility that the traveling speed of the host vehicle significantly decreases. When the traveling speed of the host vehicle excessively decreases, there is a possibility that the host vehicle obstructs the traveling of the following vehicle.

According to the vehicle driving assistance apparatus of the present invention, when the traveling speed of the host vehicle is equal to or smaller than the predetermined prohibition speed, the intermittent driving control is not executed. Therefore, the execution of the intermittent driving control can be effectively prohibited.

In addition, when the intermittent driving control is executed in a situation where a following vehicle exists, there is a possibility that the host vehicle obstructs the traveling of the following vehicle. Therefore, when the following vehicle exists, it may be preferable that the execution of the intermittent driving control is prohibited. However, when the electronic control unit cannot detect the following vehicle, the electronic control unit cannot determine whether or not the following vehicle exists.

According to the vehicle driving assistance apparatus of the present invention, when the electronic control unit cannot detect the following vehicle, the intermittent driving control is not executed. Therefore, the execution of the intermittent driving control can be effectively prohibited.

In addition, when the driving apparatus is operated in an operation mode in which the electric drive traveling state in which only mechanical power generated by the motor generator is used without using mechanical power generated by the internal combustion engine as mechanical power for driving the host vehicle occurs, the operation of the internal combustion engine is stopped, and the host vehicle is driven only by the mechanical power generated by the motor generator. Therefore, since the consumption rate of the electric power stored in the battery becomes high, there is a possibility that the necessity to input the mechanical power generated by the internal combustion engine to the motor generator to charge the battery arises earlier. Then, when the necessity to charge the battery arises, the operation of the internal combustion engine has been stopped. Thus, the internal combustion engine is started. However, at this time, when the coasting control is executed, the mechanical power generated by the internal combustion engine is not used for driving the host vehicle but is used exclusively for generating electric power by the motor generator. As a result, the energy efficiency of the internal combustion engine becomes low.

According to the vehicle driving assistance apparatus of the present invention, when the driving apparatus is operated in the operation mode in which the electric drive traveling state in which only the mechanical power generated by the motor generator is used without using the mechanical power generated by the internal combustion engine as the mechanical power for driving the host vehicle occurs, the intermittent driving control is not executed. Therefore, the execution of the intermittent driving control can be effectively prohibited.

In the vehicle driving assistance apparatus according to an aspect of the present invention, the electronic control unit may be configured to operate the motor generator by mechanical power generated by the internal combustion engine to generate electric power by the motor generator when the amount of electric power stored in the battery becomes equal to or smaller than a charging start stored electric amount. In this aspect, the charging start stored electric amount may be the same value as or a value smaller than the predetermined prohibition stored electric amount.

According to the vehicle driving assistance apparatus of this aspect of the present invention, when the amount of electric power stored in the battery becomes equal to or smaller than the charging start stored electric amount, electric power is generated by the motor generator by the mechanical power generated by the internal combustion engine. Therefore, it is possible to store in the battery the amount of electric power greater than the charging start stored electric amount.

Further, in the vehicle driving assistance apparatus according to another aspect of the present invention, an electric device which operates by electric power stored in the battery may be mounted on the host vehicle. In this aspect, the consumption rate may be a consumption rate of electric power consumed by the electric device. Further, in this aspect, the electronic control unit may be configured to determine the predetermined prohibition consumption rate based on the amount of electric power stored in the battery.

When an electric device is operating, the electric power stored in the battery is consumed. According to the vehicle driving assistance apparatus of this aspect of the present invention, it is determined whether or not the second condition is satisfied based on the consumption rate of the electric power consumed by the electric device. Therefore, the execution of the intermittent driving control can be effectively prohibited.

Furthermore, in the vehicle driving assistance apparatus according to further another aspect of the present invention, a surrounding information acquisition device which acquires information on a situation around the host vehicle may be mounted on the host vehicle. In this aspect, the electronic control unit may be configured to detect the following vehicle based on information acquired by the surrounding information acquisition device. Further, the electronic control unit may be configured not to execute the intermittent driving control when execution of the intermittent driving control is requested and a distance between the following vehicle and the host vehicle is equal to or smaller than a predetermined distance threshold. Furthermore, the electronic control unit may be configured to stop the intermittent driving control when the distance between the following vehicle and the host vehicle becomes equal to or smaller than the predetermined distance threshold while the intermittent driving control is executed.

When the intermittent driving control is executed in a situation where a following vehicle exists near the host vehicle, there is a possibility that the host vehicle obstructs the traveling of the following vehicle. According to the vehicle driving assistance apparatus of this aspect of the present invention, when the following vehicle exists within the predetermined distance threshold from the host vehicle, the intermittent driving control is not executed. Therefore, it is possible to suppress the host vehicle from obstructing the traveling of the following vehicle.

Furthermore, in the vehicle driving assistance apparatus according to further another aspect of the present invention, the operation mode may include an electric drive mode in which only mechanical power generated by the motor generator is used without using mechanical power generated by the internal combustion engine as mechanical power for driving the host vehicle, and a hybrid mode in which mechanical power generated by the internal combustion engine and the motor generator is used as mechanical power for driving the host vehicle. In this aspect, the operation mode in which the electric drive traveling state occurs may be the electric drive mode.

When the driving apparatus is operated in the electric drive mode, the operation of the internal combustion engine is stopped, and the host vehicle is driven only by the mechanical power generated by the motor generator. According to the vehicle driving assistance apparatus of this aspect of the present invention, the operation mode in which the electric drive traveling state occurs is the electric drive mode. Therefore, when the driving apparatus is operated in the electric drive mode, the intermittent driving control is not executed. Therefore, it is possible to suppress the host vehicle from obstructing the traveling of the following vehicle.

Furthermore, in the vehicle driving assistance apparatus according to further another aspect of the present invention, the electronic control unit may be configured not to execute the intermittent driving control when execution of the intermittent driving control is requested in a situation where the prohibition condition is satisfied. Further, the electronic control unit may be configured to stop the intermittent driving control when the prohibition condition is satisfied while the intermittent driving control is executed.

According to the vehicle driving assistance apparatus of this aspect of the present invention, in a situation where the prohibition condition is satisfied, even when execution of the intermittent driving control is requested, the intermittent driving control is not executed. In addition, when the prohibition condition is satisfied during the execution of the intermittent driving control, the intermittent driving control is stopped. Therefore, the execution of the intermittent driving control can be effectively prohibited.

Furthermore, a vehicle driving assistance method according to the present invention is a method for executing an intermittent driving control of driving a host vehicle by autonomously and alternately executing a propelling control of propelling the host vehicle and a coasting control of causing the host vehicle to coast. A driving apparatus which generates mechanical power and a battery which stores electric power are mounted on the host vehicle. The driving apparatus includes an internal combustion engine and a motor generator. The motor generator operates by electric power supplied from the battery to generate mechanical power and also operates by mechanical power generated by the internal combustion engine to generate electric power. Electric power generated by the motor generator is stored in the battery. The propelling control is a control of propelling the host vehicle by mechanical power generated by the internal combustion engine and/or the motor generator. The vehicle driving assistance method comprises a step of not executing the intermittent driving control when a prohibition condition is satisfied in a situation where execution of the intermittent driving control is requested. The prohibition condition is satisfied when at least one of the following is satisfied: a first condition that an amount of electric power stored in the battery is equal to or smaller than a predetermined prohibition stored electric amount; a second condition that a consumption rate of electric power stored in the battery is equal to or greater than a predetermined prohibition consumption rate; a third condition that a traveling speed of the host vehicle is equal to or smaller than a predetermined prohibition speed; a fourth condition that a following vehicle cannot be detected; and a fifth condition that the driving apparatus is operated in an operation mode in which an electric drive traveling state in which only mechanical power generated by the motor generator is used without using mechanical power generated by the internal combustion engine as mechanical power for driving the host vehicle occurs.

According to the vehicle driving assistance method of the present invention, for the same reasons as described above, the execution of the intermittent driving control can be effectively prohibited.

Furthermore, a computer-readable storage medium according to the present invention stores a vehicle driving assistance program which executes an intermittent driving control of driving a host vehicle by autonomously and alternately executing a propelling control of propelling the host vehicle and a coasting control of causing the host vehicle to coast. A driving apparatus which generates mechanical power and a battery which stores electric power are mounted on the host vehicle. The driving apparatus includes an internal combustion engine and a motor generator. The motor generator operates by electric power supplied from the battery to generate mechanical power and also operates by mechanical power generated by the internal combustion engine to generate electric power. Electric power generated by the motor generator is stored in the battery. The propelling control is a control of propelling the host vehicle by mechanical power generated by the internal combustion engine and/or the motor generator. The vehicle driving assistance program is configured not to execute the intermittent driving control when a prohibition condition is satisfied in a situation where execution of the intermittent driving control is requested. The prohibition condition is satisfied when at least one of the following is satisfied: a first condition that an amount of electric power stored in the battery is equal to or smaller than a predetermined prohibition stored electric amount; a second condition that a consumption rate of electric power stored in the battery is equal to or greater than a predetermined prohibition consumption rate; a third condition that a traveling speed of the host vehicle is equal to or smaller than a predetermined prohibition speed; a fourth condition that a following vehicle cannot be detected; and a fifth condition that the driving apparatus is operated in an operation mode in which an electric drive traveling state in which only mechanical power generated by the motor generator is used without using mechanical power generated by the internal combustion engine as mechanical power for driving the host vehicle occurs.

According to the vehicle driving assistance program of the present invention, for the same reasons as described above, the execution of the intermittent driving control can be effectively prohibited.

Constituent elements of the present invention are not limited to embodiments of the present invention described later with reference to the drawings. Other objects, other features, and accompanying advantages of the present invention will be easily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a scene in which a preceding vehicle and a following vehicle exist.

FIG. 3 is a flowchart showing a routine executed by the vehicle driving assistance apparatus according to the embodiment of the present invention.

### DETAILED DESCRIPTION

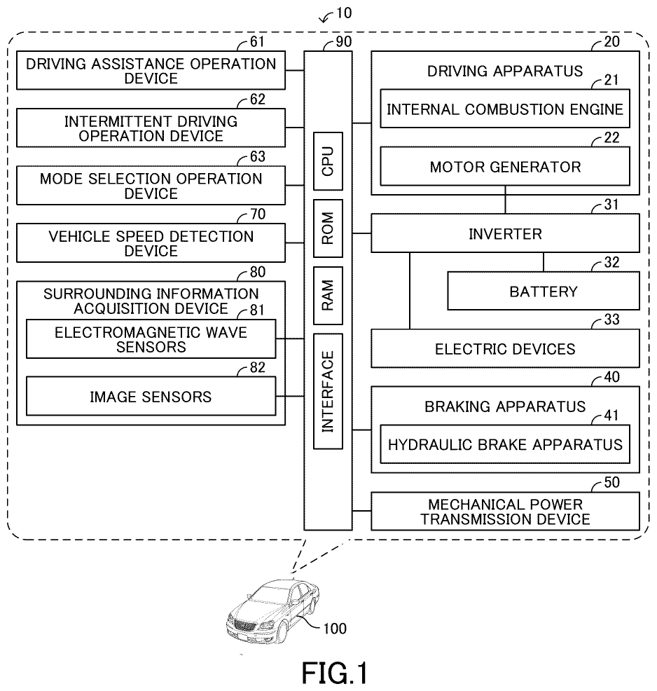

Hereinafter, a vehicle driving assistance apparatus, a vehicle driving assistance method, and a storage medium storing a vehicle driving assistance program according to an embodiment of the present invention will be described with reference to the drawings. In FIG. 1, a vehicle driving assistance apparatus 10 according to the embodiment of the present invention is shown. The vehicle driving assistance apparatus 10 is mounted on a host vehicle 100. Hereinafter, the vehicle driving assistance apparatus 10 will be described by taking, as an example, a case where an operator or a user of the host vehicle 100 is a driver of the host vehicle 100 (that is, a person who boards the host vehicle 100 and drives the host vehicle 100). However, the operator or the user of the host vehicle 100 may be a remote operator of the host vehicle 100 (that is, a person who drives the host vehicle 100 remotely without boarding the host vehicle 100). It should be noted that, in the following description, the driver of the host vehicle 100 may be simply referred to as “the driver.”

As shown in FIG. 1, the vehicle driving assistance apparatus 10 includes an ECU (electronic control unit) 90 as a control device. The ECU 90 includes a microcomputer as a main part. The microcomputer includes a CPU, a computer-readable storage medium, and an interface, and the like. The storage medium includes a ROM, a RAM, and a nonvolatile memory, and the like. The CPU realizes various functions by executing instructions, programs, or routines stored in the storage medium. In particular, in this example, the vehicle driving assistance apparatus 10 stores, in the storage medium, programs for realizing various controls executed by the vehicle driving assistance apparatus 10.

It should be noted that, in this example, the vehicle driving assistance apparatus 10 includes only one ECU 90, but the vehicle driving assistance apparatus 10 may be configured to include a plurality of ECUs, and to cause each ECU to share functions of the vehicle driving assistance apparatus 10 described below and execute them.

In addition, the vehicle driving assistance apparatus 10 may be configured to be capable of updating (upgrading) programs stored in the storage medium by wireless communication (for example, Internet communication) with external devices.

In addition, the vehicle driving assistance apparatus 10 can be applied not only to a vehicle which travels by manual driving by an operator but also to a vehicle which travels by automatic driving.

As shown in FIG. 1, the host vehicle 100 is provided with a driving apparatus 20, an inverter 31, a battery 32, electric devices 33, a braking apparatus 40, and a mechanical power transmission device 50.

The driving apparatus 20 generates mechanical power. In this example, the driving apparatus 20 includes an internal combustion engine 21 and at least one motor generator 22. The driving apparatus 20 is electrically connected to an ECU 90. The vehicle driving assistance apparatus 10 controls mechanical power generated by the driving apparatus 20 by controlling the operation of the driving apparatus 20 (that is, the internal combustion engine 21 and the motor generator 22). The mechanical power generated by the driving apparatus 20 is mainly used as driving force for driving the host vehicle 100. Therefore, in this example, the host vehicle 100 is a so-called hybrid vehicle or plug-in hybrid vehicle.

It should be noted that, in this example, when electric power is supplied from the battery 32 to the motor generator 22, the motor generator 22 operates as an electric motor to generate mechanical power. That is, the motor generator 22 operates as an electric motor by the electric power supplied from the battery 32 to generate mechanical power. On the other hand, when mechanical power is input to the motor generator 22, the motor generator 22 operates as a generator to generate electric power. More specifically, when mechanical power generated by the internal combustion engine 21 is input to the motor generator 22, the motor generator 22 generates electric power. That is, the motor generator 22 is operated by the mechanical power generated by the internal combustion engine 21 to generate electric power. In addition, when traveling energy of the host vehicle 100 is input as mechanical power to the motor generator 22 via a mechanical power transmission path, the motor generator 22 also generates electric power. That is, the motor generator 22 generates electric power using the traveling energy of the host vehicle 100 as mechanical power. It should be noted that the mechanical power transmission path is a path established by the mechanical power transmission device 50, and is a path which transmits mechanical power among the internal combustion engine 21, the motor generator 22, and driven wheels of the host vehicle 100.

The battery 32 stores electric power. The inverter 31 supplies electric power stored in the battery 32 to the motor generator 22 and the electric devices 33 and the like. The electric devices 33 operate by the electric power stored in the battery 32. The electric devices 33 include, for example, a heating device for heating an interior of the host vehicle 100. In addition, the inverter 31 also supplies electric power generated by the motor generator 22 to the battery 32. The battery 32 stores the electric power supplied from the inverter 31. That is, the electric power generated by the motor generator 22 is stored in the battery 32.

The inverter 31 is electrically connected to the ECU 90. The vehicle driving assistance apparatus 10 controls the supply of electric power via the inverter 31 by controlling the operation of the inverter 31.

The braking apparatus 40 applies braking force to the host vehicle 100 (in particular, wheels of the host vehicle 100). In this example, the braking apparatus 40 includes a hydraulic brake apparatus 41. The braking apparatus 40 is electrically connected to the ECU 90. The vehicle driving assistance apparatus 10 controls braking force applied to the host vehicle 100 by controlling the operation of the braking apparatus 40 (more specifically, the operation of the hydraulic brake apparatus 41).

The mechanical power transmission device 50 mainly transmits mechanical power output from the driving apparatus 20 to the driven wheels of the host vehicle 100 as driving force. The mechanical power transmission device 50 is, for example, a transmission. The mechanical power transmission device 50 is electrically connected to the ECU 90.

The vehicle driving assistance apparatus 10 establishes the mechanical power transmission path by controlling the operation of the mechanical power transmission device 50 and transmits mechanical power output from the driving apparatus 20 to the driven wheels of the host vehicle 100 as driving force. Therefore, the mechanical power transmission path is a path which transmits mechanical power generated by the driving apparatus 20 to the driven wheels of the host vehicle 100. On the other hand, the vehicle driving assistance apparatus 10 also cuts off the mechanical power transmission path by controlling the operation of the mechanical power transmission device 50 such that mechanical power generated by the driving apparatus 20 is not transmitted to the driven wheels of the host vehicle 100.

It should be noted that, in this example, when a deceleration request occurs while the mechanical power transmission path is established, the vehicle driving assistance apparatus 10 inputs traveling energy of the host vehicle 100 as mechanical power to the motor generator 22 via the mechanical power transmission path. Thereby, the motor generator 22 is operated by the traveling energy of the host vehicle 100. Thus, the host vehicle 100 is decelerated. In addition, the motor generator 22 generates electric power. The generated electric power is charged to the battery 32 via the inverter 31. It should be noted that the deceleration request is a request to decelerate the host vehicle 100. The deceleration request occurs, for example, for decelerating the host vehicle 100 during execution of a steady driving control described later.

Further, the host vehicle 100 is provided with a driving assistance operation device 61, an intermittent driving operation device 62, a mode selection operation device 63, a vehicle speed detection device 70, and a surrounding information acquisition device 80.

The driving assistance operation device 61 is operated by the driver. The driver requests execution or stop of a driving assistance control described later by operating the driving assistance operation device 61. The driving assistance operation device 61 is electrically connected to the ECU 90.

When the driving assistance operation device 61 is operated in a situation where the driving assistance control is not executed, the vehicle driving assistance apparatus 10 determines that execution of the driving assistance control is requested. On the other hand, when the driving assistance operation device 61 is operated in a situation where the driving assistance control is executed, the vehicle driving assistance apparatus 10 determines that stopping of the driving assistance control is requested.

The intermittent driving operation device 62 is also operated by the driver. The driver requests execution or stop of an intermittent driving control described later by operating the intermittent driving operation device 62. The intermittent driving operation device 62 is electrically connected to the ECU 90.

When the intermittent driving operation device 62 is operated in a situation where the execution of the driving assistance control is requested but the intermittent driving control is not executed, the vehicle driving assistance apparatus 10 determines that execution of the intermittent driving control is requested. On the other hand, when the intermittent driving operation device 62 is operated in a situation where the intermittent driving control is executed, the vehicle driving assistance apparatus 10 determines that stopping of the intermittent driving control is requested and that execution of a steady driving control described later is requested.

The mode selection operation device 63 is also operated by the driver. The driver selects an operation mode by operating the mode selection operation device 63. The operation mode is a mode for operating the driving apparatus 20. In this example, the operation mode includes an EV mode, an HV mode, and an automatic switching mode.

The EV mode (or electric drive mode) is a mode in which only motor mechanical power Fm is used without using engine mechanical power Fe as mechanical power for driving the host vehicle 100. Therefore, when the EV mode is selected as the operation mode, the operation of the internal combustion engine 21 is stopped unless a battery charging request occurs.

It should be noted that the engine mechanical power Fe is mechanical power generated by the internal combustion engine 21. In addition, the motor mechanical power Fm is mechanical power generated by the motor generator 22.

In addition, the battery charging request is a request to charge the battery 32. The battery charging request occurs when a battery stored electric amount SOC is equal to or smaller than a predetermined value (that is, a charging start stored electric amount SOCmin). In this example, when the battery charging request occurs, the engine mechanical power Fe is input to the motor generator 22. Then, the motor generator 22 operates as a generator by the input mechanical power to generate electric power. The generated electric power is stored in the battery 32 via the inverter 31. Therefore, when the operation mode is the EV mode, the operation of the internal combustion engine 21 has been stopped. Thus, when the battery charging request occurs, the internal combustion engine 21 is started. It should be noted that the battery stored electric amount SOC is an amount of electric power stored in the battery 32.

As described above, the vehicle driving assistance apparatus 10 operates the motor generator 22 by the mechanical power generated by the internal combustion engine 21 to generate electric power by the motor generator 22 when the battery stored electric amount SOC becomes equal to or smaller than the charging start stored electric amount SOCmin.

The HV mode (or hybrid mode) is a mode in which both the engine mechanical power Fe and the motor mechanical power Fm are used as mechanical power for driving the host vehicle 100. Therefore, when the operation mode is the HV mode, the internal combustion engine 21 and the motor generator 22 are operated. It should be noted that when the battery charging request occurs in a situation where the operation mode is the HV mode, the engine mechanical power Fe is input to the motor generator 22, and the motor generator 22 operates as a generator by the input engine mechanical power Fe to generate electric power. The generated electric power is stored in the battery 32 via the inverter 31.

The automatic switching mode is a mode in which the operation mode is automatically switched between the EV mode and the HV mode depending on a requested torque TQreq and a host vehicle speed V1 and the like. The requested torque TQreq is a torque requested to be output from the driving apparatus 20.

It should be noted that when the operation mode is the HV mode, the host vehicle 100 may be started using only the motor mechanical power Fm without using the engine mechanical power Fe. That is, when the operation mode is the HV mode, the driving apparatus 20 may be operated in the EV mode temporarily at the time of starting of the host vehicle 100. Therefore, both the HV mode and the automatic switching mode are the same in that the operation mode is switched between the HV mode and the EV mode. However, when the operation mode is the HV mode, the EV mode is used only in very limited scenes such as at the start of the host vehicle 100, whereas when the operation mode is the automatic switching mode, the EV mode is used in a wider range of scenes. In this respect, it can be said that the HV mode and the automatic switching mode are different modes.

The vehicle speed detection device 70 is used for detecting a host vehicle speed V1. The host vehicle speed V1 is a traveling speed of the host vehicle 100. The vehicle speed detection device 70 includes, for example, wheel rotation speed sensors provided on respective wheels of the host vehicle 100. The vehicle speed detection device 70 is electrically connected to the ECU 90. The vehicle driving assistance apparatus 10 acquires the host vehicle speed V1 by means of the vehicle speed detection device 70.

The surrounding information acquisition device 80 is used for acquiring information on a situation around the host vehicle 100. In this example, the surrounding information acquisition device 80 includes a plurality of electromagnetic wave sensors 81 and a plurality of image sensors 82.

The electromagnetic wave sensors 81 are electrically connected to the ECU 90. The electromagnetic wave sensor 81 is, for example, a radar sensor such as a millimeter wave radar. The vehicle driving assistance apparatus 10 acquires information (object information IO) on objects existing around the host vehicle 100 as surrounding information IS by the electromagnetic wave sensors 81. In particular, the object information IO includes information on a preceding vehicle 200 and a following vehicle 300.

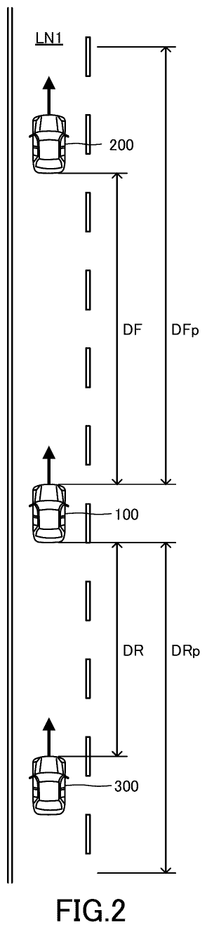

As shown in FIG. 2, the preceding vehicle 200 is another vehicle which travels in a host vehicle traveling lane LN1 and exists within a predetermined forward distance DFp in front of the host vehicle 100. The following vehicle 300 is another vehicle which travels in the host vehicle traveling lane LN1 and exists within a predetermined rearward distance DRp behind the host vehicle 100. The host vehicle traveling lane LN1 is a lane in which the host vehicle 100 is traveling.

The image sensors 82 are electrically connected to the ECU 90. The image sensor 82 is, for example, a camera sensor. The vehicle driving assistance apparatus 10 acquires image information IC on the surroundings of the host vehicle 100 as the surrounding information IS by means of the image sensors 82. In particular, the image information IC includes information on the preceding vehicle 200 and the following vehicle 300.

### <Operation of Vehicle Driving Assistance Apparatus>

Next, operation of the vehicle driving assistance apparatus 10 will be described.

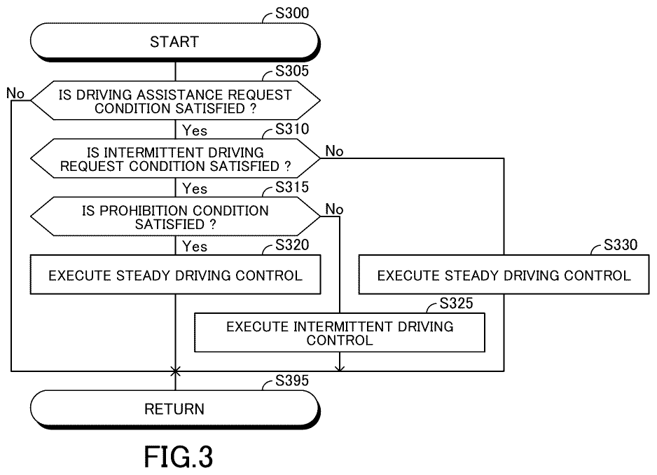

The vehicle driving assistance apparatus 10 executes a driving assistance control when predetermined conditions are satisfied by executing a routine shown in FIG. 3 at predetermined time intervals. The driving assistance control is a control of autonomously driving the host vehicle 100. The driving assistance control includes a steady driving control and an intermittent driving control.

The steady driving control includes a steady vehicle speed control and a steady inter-vehicle distance control.

In a situation where the preceding vehicle 200 exists as shown in FIG. 2, the vehicle driving assistance apparatus 10 executes the steady inter-vehicle distance control as the steady driving control. On the other hand, in a situation where the preceding vehicle 200 does not exist, the vehicle driving assistance apparatus 10 executes the steady vehicle speed control as the steady driving control. The vehicle driving assistance apparatus 10 detects the preceding vehicle 200 based on surrounding information IS.

The steady vehicle speed control is a control of autonomously driving the host vehicle 100 by controlling operations of the driving apparatus 20 and the braking apparatus 40 such that the host vehicle speed V1 is maintained at a set vehicle speed Vset. The set vehicle speed Vset is set by the driver.

Thus, the steady vehicle speed control is a control of driving the host vehicle 100 by autonomously accelerating and decelerating the host vehicle 100 such that, in a situation where the preceding vehicle 200 does not exist, the host vehicle speed V1 is maintained at a predetermined speed (that is, the set vehicle speed Vset).

On the other hand, the steady inter-vehicle distance control is a control of autonomously driving the host vehicle 100 by controlling operations of the driving apparatus 20 and the braking apparatus 40 such that a preceding vehicle distance DF is maintained at a set inter-vehicle distance DFset. The preceding vehicle distance DF is a distance between the host vehicle 100 and the preceding vehicle 200. The vehicle driving assistance apparatus 10 acquires the preceding vehicle distance DF based on the surrounding information IS. In addition, the set inter-vehicle distance DFset is set by the driver.

Thus, the steady inter-vehicle distance control is a control of driving the host vehicle 100 by autonomously accelerating and decelerating the host vehicle 100 such that, in a situation where the preceding vehicle 200 exists, the preceding vehicle distance DF is maintained at a predetermined distance (that is, the set inter-vehicle distance DFset).

In addition, the intermittent driving control includes an intermittent vehicle speed control and an intermittent inter-vehicle distance control.

The intermittent driving control includes a propelling control and a coasting control. The intermittent driving control is a control of driving the host vehicle 100 by autonomously and alternately executing the propelling control and the coasting control as long as predetermined conditions described later are not satisfied.

The propelling control is a control of propelling the host vehicle 100 by the driving force. In particular, in this example, the propelling control is a control of propelling the host vehicle 100 by the driving force such that the host vehicle 100 is accelerated. The vehicle driving assistance apparatus 10 propels the host vehicle 100 by applying mechanical power generated by the driving apparatus 20 to the host vehicle 100 during execution of the propelling control. That is, the propelling control is a control of propelling the host vehicle 100 by mechanical power generated by the internal combustion engine 21 and/or the motor generator 22.

It should be noted that an optimum propelling control may be adopted as the propelling control. The optimum propelling control is a control of propelling the host vehicle 100 by applying mechanical power generated by the driving apparatus 20 while controlling operation of the driving apparatus 20 such that energy efficiency of the driving apparatus 20 becomes highest. It should be noted that the energy efficiency of the driving apparatus 20 is energy efficiency for generating mechanical power by the driving apparatus 20. In addition, in the following description, the energy efficiency of the internal combustion engine 21 is energy efficiency for generating mechanical power by the internal combustion engine 21.

The coasting control is a control of causing the host vehicle 100 to coast. The vehicle driving assistance apparatus 10 causes the host vehicle 100 to coast by stopping application of mechanical power from the driving apparatus 20 to the host vehicle 100 during execution of the coasting control. In this example, the vehicle driving assistance apparatus 10 stops application of mechanical power from the driving apparatus 20 to the host vehicle 100 by cutting off the power transmission path during execution of the coasting control. As described above, the mechanical power transmission path is a path which applies mechanical power generated by the driving apparatus 20 to the host vehicle 100 as the driving force. The vehicle driving assistance apparatus 10 cuts off the mechanical power transmission path by controlling operation of the mechanical power transmission device 50. In addition, during execution of the coasting control, the operation of the internal combustion engine 21 is stopped.

In a situation where the preceding vehicle 200 exists as shown in FIG. 2, the vehicle driving assistance apparatus 10 executes the intermittent inter-vehicle distance control as the intermittent driving control. On the other hand, in a situation where the preceding vehicle 200 does not exist, the vehicle driving assistance apparatus 10 executes the intermittent vehicle speed control as the intermittent driving control.

The intermittent vehicle speed control is a control of autonomously driving the host vehicle 100 by alternately and repeatedly executing the propelling control and the coasting control such that the host vehicle speed V1 is maintained at a speed within a target vehicle speed range RVtgt. Therefore, during execution of the intermittent vehicle speed control, the vehicle driving assistance apparatus 10 alternately switches and executes the propelling control and the coasting control such that the host vehicle speed V1 falls within a predetermined range (that is, the target vehicle speed range RVtgt).

During execution of the intermittent vehicle speed control, when the host vehicle speed V1 increases by execution of the propelling control and reaches an upper limit speed Vmax, the vehicle driving assistance apparatus 10 ends the propelling control and starts the coasting control. The upper limit speed Vmax is an upper limit value of the target vehicle speed range RVtgt. In this example, the set vehicle speed Vset is set as the upper limit speed Vmax (Vmax=Vset).

On the other hand, during execution of the intermittent vehicle speed control, when the host vehicle speed V1 decreases by execution of the coasting control and reaches a lower limit speed Vmin, the vehicle driving assistance apparatus 10 ends the coasting control and starts the propelling control. The lower limit speed Vmin is a lower limit value of the target vehicle speed range RVtgt. In this example, the lower limit speed Vmin is a value obtained by subtracting a target vehicle speed control width WVtgt from the set vehicle speed Vset (Vmin=Vset−WVtgt).

Thus, the intermittent vehicle speed control is a control of driving the host vehicle 100 by autonomously and alternately executing the propelling control and the coasting control such that, in a situation where the preceding vehicle 200 does not exist, the host vehicle speed V1 falls within a predetermined speed range (that is, the target vehicle speed range RVtgt).

The intermittent inter-vehicle distance control is a control of autonomously driving the host vehicle 100 by autonomously and alternately executing the propelling control and the coasting control such that the preceding vehicle distance DF is maintained at a distance within a target inter-vehicle distance range RDtgt. Therefore, during execution of the intermittent inter-vehicle distance control, the vehicle driving assistance apparatus 10 alternately switches and executes the propelling control and the coasting control such that the preceding vehicle distance DF falls within a predetermined range (that is, the target inter-vehicle distance range RDtgt).

During execution of the intermittent inter-vehicle distance control, when the preceding vehicle distance DF is shortened by execution of the propelling control and reaches a lower limit inter-vehicle distance DFmin, the vehicle driving assistance apparatus 10 ends the propelling control and starts the coasting control. The lower limit inter-vehicle distance DFmin is a lower limit value of the target inter-vehicle distance range RDtgt. In this example, the set inter-vehicle distance DFset is set as the lower limit inter-vehicle distance DFmin (DFmin=DFset).

On the other hand, during execution of the intermittent inter-vehicle distance control, when the preceding vehicle distance DF becomes long by execution of the coasting control and reaches an upper limit inter-vehicle distance DFmax, the vehicle driving assistance apparatus 10 ends the coasting control and starts the propelling control. The upper limit inter-vehicle distance DFmax is an upper limit value of the target inter-vehicle distance range RDtgt. In this example, the upper limit inter-vehicle distance DFmax is a value obtained by adding a target inter-vehicle distance control width WDtgt to the lower limit inter-vehicle distance DFmin (DFmax=DFmin+WDtgt).

Thus, the intermittent inter-vehicle distance control is a control of driving the host vehicle 100 by autonomously and alternately executing the propelling control and the coasting control such that, in a situation where the preceding vehicle 200 exists, the preceding vehicle distance DF falls within a predetermined distance range (that is, the target inter-vehicle distance range RDtgt).

It should be noted that, during execution of the propelling control, when the host vehicle speed V1 reaches the upper limit speed Vmax before the preceding vehicle distance DF reaches the lower limit inter-vehicle distance DFmin, the vehicle driving assistance apparatus 10 stops the propelling control and executes an upper limit vehicle speed maintaining control of controlling acceleration and deceleration of the host vehicle 100 such that the host vehicle speed V1 is maintained at the upper limit speed Vmax.

In addition, as shown in FIG. 2, a following vehicle 300 may exist. Here, when the intermittent driving control is executed in a situation where the following vehicle 300 exists relatively close to the host vehicle 100, since the host vehicle speed V1 changes relatively greatly, there is a possibility that the host vehicle 100 obstructs traveling of the following vehicle 300. Therefore, when execution of the intermittent driving control is requested and a following vehicle distance DR is equal to or smaller than a predetermined distance threshold (that is, a predetermined following vehicle inter-vehicle distance DRth), the vehicle driving assistance apparatus 10 does not execute the intermittent driving control. That is, when execution of the intermittent driving control is requested and the following vehicle distance DR is equal to or smaller than the predetermined following vehicle inter-vehicle distance DRth, execution of the intermittent driving control is prohibited. In addition, when the following vehicle distance DR becomes equal to or smaller than the predetermined following vehicle inter-vehicle distance DRth while the intermittent driving control is executed, the vehicle driving assistance apparatus 10 stops the intermittent driving control. That is, when the following vehicle distance DR becomes equal to or smaller than the predetermined following vehicle inter-vehicle distance DRth while the intermittent driving control is executed, the intermittent driving control is prohibited.

It should be noted that the vehicle driving assistance apparatus 10 detects the following vehicle 300 based on the surrounding information IS. In addition, the following vehicle distance DR is a distance between the host vehicle 100 and the following vehicle 300. The vehicle driving assistance apparatus 10 acquires the following vehicle distance DR based on the surrounding information IS.

The vehicle driving assistance apparatus 10 starts a process from a step S300 of the routine shown in FIG. 3 at a predetermined timing. Then, the vehicle driving assistance apparatus 10 proceeds with the process to a step S305 to determine whether or not a driving assistance request condition C1 is satisfied. The driving assistance request condition C1 is satisfied when execution of the driving assistance control is requested. On the other hand, the driving assistance request condition C1 is not satisfied when stopping of the driving assistance control is requested.

When the driving assistance request condition C1 is not satisfied, the vehicle driving assistance apparatus 10 determines “No” at the step S305, and proceeds with the process directly to a step S395 to terminate the process of this routine once. On the other hand, when the driving assistance request condition C1 is satisfied, the vehicle driving assistance apparatus 10 determines “Yes” at the step S305, and proceeds with the process to a step S310 to determine whether or not an intermittent driving request condition C2 is satisfied. The intermittent driving request condition C2 is satisfied when execution of the intermittent driving control is requested. On the other hand, the intermittent driving request condition C2 is not satisfied when stopping of the intermittent driving control is requested.

When the intermittent driving request condition C2 is not satisfied, the vehicle driving assistance apparatus 10 determines “No” at the step S310, and proceeds with the process to a step S330 to execute the steady driving control. Next, the vehicle driving assistance apparatus 10 proceeds with the process to the step S395 to terminate the process of this routine once.

On the other hand, when the intermittent driving request condition C2 is satisfied, the vehicle driving assistance apparatus 10 determines “Yes” at the step S310, and proceeds with the process to a step S315 to determine whether or not a prohibition condition C3 is satisfied. The prohibition condition C3 is satisfied when any one of a first condition C31 to a fifth condition C35 described below is satisfied.

### <First Condition>

As described above, in this example, when a battery stored electric amount SOC becomes equal to or smaller than a charging start stored electric amount SOCmin, a battery charging request occurs. At this time, when the host vehicle 100 is coasting by the coasting control, the operation of the internal combustion engine 21 has been stopped. Thus, the internal combustion engine 21 is started. However, while the coasting control is executed, the engine mechanical power Fe is not used for driving the host vehicle 100 but is used exclusively for generating electric power by the motor generator 22. As a result, energy efficiency of the internal combustion engine 21 becomes low.

For such reasons, the prohibition condition C3 is configured to be satisfied when the first condition C31 that the battery stored electric amount SOC is equal to or smaller than the charging start stored electric amount SOCmin is satisfied. In other words, the prohibition condition C3 is configured to be satisfied when the first condition C31 that the battery charging request occurs is satisfied. In other words, the prohibition condition C3 is configured to be satisfied when the first condition C31 that an amount of electric power stored in the battery 32 is equal to or smaller than a predetermined prohibition stored electric amount SOCth is satisfied. It should be noted that the predetermined prohibition stored electric amount SOCth here is the charging start stored electric amount SOCmin.

It should be noted that execution of the coasting control may be prohibited in anticipation that the battery charging request will occur in the near future. That is, the prohibition condition C3 may be configured to be satisfied when the first condition C31 that the battery stored electric amount SOC is equal to or smaller than a pre-prohibition stored electric amount SOCpre which is greater than the charging start stored electric amount SOCmin is satisfied. In other words, the prohibition condition C3 may be configured to be satisfied when the first condition C31 that it is predicted that the battery charging request will occur during execution of the coasting control is satisfied. In this case, it can be said that the prohibition condition C3 is configured to be satisfied when the first condition C31 that an amount of electric power stored in the battery 32 is equal to or smaller than a predetermined prohibition stored electric amount SOCth is satisfied. It should be noted that the predetermined prohibition stored electric amount SOCth here is the pre-prohibition stored electric amount SOCpre.

Thus, the charging start stored electric amount SOCmin is the same value as the predetermined prohibition stored electric amount SOCth or a value smaller than the predetermined prohibition stored electric amount SOCth.

### <Second Condition>

In addition, when the electric device 33 such as a heating device for heating an interior of the host vehicle 100 is operating, a consumption rate ΔSOC of the electric power stored in the battery 32 becomes high. Therefore, even if the battery stored electric amount SOC is relatively large, there is a possibility that the battery charging request occurs early. Then, when the battery charging request occurs, the engine mechanical power Fe is input to the motor generator 22 and the battery 32 is charged. At this time, when the host vehicle 100 is coasting by the coasting control, the operation of the internal combustion engine 21 has been stopped. Thus, the internal combustion engine 21 is started. However, while the coasting control is executed, the engine mechanical power Fe is not used for driving the host vehicle 100 but is used exclusively for generating electric power by the motor generator 22. As a result, energy efficiency of the internal combustion engine 21 becomes low.

For such reasons, the prohibition condition C3 is configured to be satisfied when the second condition C32 that the consumption rate ΔSOC of the electric power stored in the battery 32 is equal to or greater than a predetermined prohibition consumption rate ΔSOCth is satisfied. Here, the consumption rate ΔSOC of the electric power stored in the battery 32 is a consumption rate of electric power consumed by the electric device 33 in operation. In addition, the vehicle driving assistance apparatus 10 determines the predetermined prohibition consumption rate ΔSOCth based on the battery stored electric amount SOC. In this example, the vehicle driving assistance apparatus 10 sets the predetermined prohibition consumption rate ΔSOCth to a smaller value as the battery stored electric amount SOC is smaller. In particular, the prohibition condition C3 is configured to be satisfied when the second condition C32 that the electric device 33 is in operation is satisfied. In other words, the prohibition condition C3 is configured to be satisfied when the second condition C32 that it is predicted that the battery charging request will occur during execution of the coasting control is satisfied. In other words, the prohibition condition C3 is configured to be satisfied when the second condition C32 that a level of possibility that the battery charging request will occur during execution of the coasting control is equal to or greater than a predetermined level threshold is satisfied.

### <Third Condition>

In addition, when the coasting control is executed in a state where an average speed of the host vehicle 100 is relatively low, there is a possibility that the host vehicle speed V1 significantly decreases. When the host vehicle speed V1 excessively decreases, there is a possibility that the host vehicle 100 obstructs traveling of the following vehicle 300.

For such reasons, the prohibition condition C3 is configured to be satisfied when the third condition C33 that the host vehicle speed V1 is equal to or smaller than a predetermined prohibition speed Vth is satisfied. In other words, the prohibition condition C3 is configured to be satisfied when the third condition C33 that it is predicted that the host vehicle 100 will obstruct traveling of the following vehicle 300 due to execution of the coasting control is satisfied. More specifically, the prohibition condition C3 is configured to be satisfied when the third condition C33 that a level of possibility that the host vehicle 100 will obstruct traveling of the following vehicle 300 due to execution of the coasting control is equal to or greater than a predetermined level threshold is satisfied.

### <Fourth Condition>

In addition, when the intermittent driving control is executed in a state where the following vehicle distance DR is equal to or smaller than the predetermined following vehicle inter-vehicle distance DRth, there is a possibility that the host vehicle 100 obstructs traveling of the following vehicle 300. Therefore, in this example, when the following vehicle distance DR is equal to or smaller than the predetermined following vehicle inter-vehicle distance DRth, execution of the intermittent driving control is prohibited. However, when the vehicle driving assistance apparatus 10 cannot detect the following vehicle 300 based on the surrounding information IS, the vehicle driving assistance apparatus 10 cannot determine whether or not the following vehicle distance DR is equal to or smaller than the predetermined following vehicle inter-vehicle distance DRth.

For such reasons, the prohibition condition C3 is configured to be satisfied when the fourth condition C34 that the vehicle driving assistance apparatus 10 cannot detect the following vehicle 300 is satisfied.

### <Fifth Condition>

In addition, as described above, when the operation mode is the EV mode, the operation of the internal combustion engine 21 is stopped and the host vehicle 100 is driven only by the motor mechanical power Fm. Therefore, since the consumption rate ΔSOC of the electric power stored in the battery 32 becomes high, there is a possibility that the battery charging request occurs early. Then, when the battery charging request occurs, the operation of the internal combustion engine 21 has been stopped. Thus, the internal combustion engine 21 is started. However, at this time, when the coasting control is executed, the engine mechanical power Fe is not used for driving the host vehicle 100 but is used exclusively for generating electric power by the motor generator 22. As a result, energy efficiency of the internal combustion engine 21 becomes low.

In addition, when the operation mode is the automatic switching mode, the driving apparatus 20 may be operated in the EV mode. At this time, the operation of the internal combustion engine 21 is stopped and the host vehicle 100 is driven only by the motor mechanical power Fm. Therefore, since the consumption rate ΔSOC of the electric power stored in the battery 32 becomes high, there is a possibility that the battery charging request occurs early. Then, when the battery charging request occurs and the internal combustion engine 21 has been stopped, the internal combustion engine 21 is started. However, at this time, when the coasting control is executed, the engine mechanical power Fe is not used for driving the host vehicle 100 but is used exclusively for generating electric power by the motor generator 22. As a result, energy efficiency of the internal combustion engine 21 becomes low.

In addition, there is an optimum switching period Topt for switching between the propelling control and the coasting control, within which energy efficiency of the driving apparatus 20 becomes maximum as much as possible. However, the optimum switching period Topt when the operation mode is the HV mode differs from the optimum switching period Topt when the operation mode is the EV mode. Therefore, when the intermittent driving control is continued even after the operation mode is switched from the HV mode to the EV mode during execution of the intermittent driving control, a period for switching between the propelling control and the coasting control changes, which may give the driver a sense of incongruity. However, if the optimum switching period Topt in the EV mode is made the same period as the optimum switching period Topt in the HV mode so as not to give the driver a sense of incongruity, energy efficiency of the driving apparatus 20 becomes low.

For such reasons, the prohibition condition C3 is configured to be satisfied when the fifth condition C35 that the operation mode is an operation mode other than the HV mode is satisfied. In particular, in this example, the prohibition condition C3 is configured to be satisfied when the fifth condition C35 that the operation mode is the EV mode or the automatic switching mode is satisfied. That is, the prohibition condition C3 is configured to be satisfied when the fifth condition C35 that the driving apparatus 20 is operated in an operation mode in which an electric drive traveling state in which only mechanical power generated by the motor generator 22 is used without using mechanical power generated by the internal combustion engine 21 as mechanical power for driving the host vehicle 100 occurs is satisfied. It should be noted that the operation mode in which the electric drive traveling state occurs here is the EV mode or the automatic switching mode.

It should be noted that the prohibition condition C3 may be configured to be satisfied when two or more of the first condition C31 to the fifth condition C35 described above are satisfied.

When the prohibition condition C3 is not satisfied, the vehicle driving assistance apparatus 10 determines “No” at the step S315, and proceeds with the process to a step S325 to execute the intermittent inter-vehicle distance control. Next, the vehicle driving assistance apparatus 10 proceeds with the process to the step S395 to terminate the process of this routine once.

On the other hand, when the prohibition condition C3 is satisfied, the vehicle driving assistance apparatus 10 determines “Yes” at the step S315, and proceeds with the process to a step S320 to execute the steady driving control. That is, the vehicle driving assistance apparatus 10 executes the steady driving control without executing the intermittent inter-vehicle distance control. Next, the vehicle driving assistance apparatus 10 proceeds with the process to the step S395 to terminate the process of this routine once.

Thus, when the execution of the intermittent driving control is requested and the prohibition condition C3 is satisfied, the vehicle driving assistance apparatus 10 does not execute the intermittent driving control. In particular, in this example, when the execution of the intermittent driving control is requested and the prohibition condition C3 is satisfied, the vehicle driving assistance apparatus 10 does not execute the intermittent driving control, and when the prohibition condition C3 is satisfied while the intermittent driving control is executed, the vehicle driving assistance apparatus 10 stops the intermittent driving control. That is, when the prohibition condition C3 is satisfied, execution of the intermittent driving control is prohibited.

The above is the operation of the vehicle driving assistance apparatus 10.

According to the vehicle driving assistance apparatus 10, when the prohibition condition C3 is satisfied, execution of the intermittent driving control is prohibited. That is, in a scene where execution of the intermittent driving control is not preferable, execution of the intermittent driving control is prohibited. Therefore, the execution of the intermittent driving control can be effectively prohibited.

It should be noted that the present invention is not limited to the above embodiment, and various modified examples can be adopted within the scope of the present invention.

What is claimed is:

1. A vehicle driving assistance apparatus comprising an electronic control unit which executes an intermittent driving control of driving a host vehicle by autonomously and alternately executing a propelling control of propelling the host vehicle and a coasting control of causing the host vehicle to coast,
wherein a driving apparatus which generates mechanical power and a battery which stores electric power are mounted on the host vehicle,
the driving apparatus includes an internal combustion engine and a motor generator,
the motor generator operates by electric power supplied from the battery to generate mechanical power and also operates by mechanical power generated by the internal combustion engine to generate electric power,
electric power generated by the motor generator is stored in the battery,
the propelling control is a control of propelling the host vehicle by mechanical power generated by the internal combustion engine and/or the motor generator,
the electronic control unit is configured not to execute the intermittent driving control when a prohibition condition is satisfied in a situation where execution of the intermittent driving control is requested, and
the prohibition condition is satisfied when at least one of the following is satisfied:
a first condition that an amount of electric power stored in the battery is equal to or smaller than a predetermined prohibition stored electric amount;
a second condition that a consumption rate of electric power stored in the battery is equal to or greater than a predetermined prohibition consumption rate;
a third condition that a traveling speed of the host vehicle is equal to or smaller than a predetermined prohibition speed;
a fourth condition that the electronic control unit cannot detect a following vehicle; and
a fifth condition that the driving apparatus is operated in an operation mode in which an electric drive traveling state in which only mechanical power generated by the motor generator is used without using mechanical power generated by the internal combustion engine as mechanical power for driving the host vehicle occurs.

2. The vehicle driving assistance apparatus according to claim 1,
wherein the electronic control unit is configured to operate the motor generator by mechanical power generated by the internal combustion engine to generate electric power by the motor generator when the amount of electric power stored in the battery becomes equal to or smaller than a charging start stored electric amount, and
the charging start stored electric amount is the same value as or a value smaller than the predetermined prohibition stored electric amount.

3. The vehicle driving assistance apparatus according to claim 1,
wherein an electric device which operates by electric power stored in the battery is mounted on the host vehicle,
the consumption rate is a consumption rate of electric power consumed by the electric device, and
the electronic control unit is configured to determine the predetermined prohibition consumption rate based on the amount of electric power stored in the battery.

4. The vehicle driving assistance apparatus according to claim 1,
wherein a surrounding information acquisition device which acquires information on a situation around the host vehicle is mounted on the host vehicle, and
the electronic control unit is configured to:
detect the following vehicle based on information acquired by the surrounding information acquisition device;
not execute the intermittent driving control when execution of the intermittent driving control is requested and a distance between the following vehicle and the host vehicle is equal to or smaller than a predetermined distance threshold; and
stop the intermittent driving control when the distance between the following vehicle and the host vehicle becomes equal to or smaller than the predetermined distance threshold while the intermittent driving control is executed.

5. The vehicle driving assistance apparatus according to claim 1,
wherein the operation mode includes:
an electric drive mode in which only mechanical power generated by the motor generator is used without using mechanical power generated by the internal combustion engine as mechanical power for driving the host vehicle; and
a hybrid mode in which mechanical power generated by the internal combustion engine and the motor generator is used as mechanical power for driving the host vehicle, and
the operation mode in which the electric drive traveling state occurs is the electric drive mode.

6. The vehicle driving assistance apparatus according to claim 1,
wherein the electronic control unit is configured to:
not execute the intermittent driving control when execution of the intermittent driving control is requested in a situation where the prohibition condition is satisfied, and
stop the intermittent driving control when the prohibition condition is satisfied while the intermittent driving control is executed.

7. A vehicle driving assistance method for executing an intermittent driving control of driving a host vehicle by autonomously and alternately executing a propelling control of propelling the host vehicle and a coasting control of causing the host vehicle to coast,
wherein a driving apparatus which generates mechanical power and a battery which stores electric power are mounted on the host vehicle,
the driving apparatus includes an internal combustion engine and a motor generator,
the motor generator operates by electric power supplied from the battery to generate mechanical power and also operates by mechanical power generated by the internal combustion engine to generate electric power,
electric power generated by the motor generator is stored in the battery,
the propelling control is a control of propelling the host vehicle by mechanical power generated by the internal combustion engine and/or the motor generator,
the vehicle driving assistance method comprises a step of not executing the intermittent driving control when a prohibition condition is satisfied in a situation where execution of the intermittent driving control is requested, and
the prohibition condition is satisfied when at least one of the following is satisfied:
a first condition that an amount of electric power stored in the battery is equal to or smaller than a predetermined prohibition stored electric amount;
a second condition that a consumption rate of electric power stored in the battery is equal to or greater than a predetermined prohibition consumption rate;
a third condition that a traveling speed of the host vehicle is equal to or smaller than a predetermined prohibition speed;
a fourth condition that a following vehicle cannot be detected; and
a fifth condition that the driving apparatus is operated in an operation mode in which an electric drive traveling state in which only mechanical power generated by the motor generator is used without using mechanical power generated by the internal combustion engine as mechanical power for driving the host vehicle occurs.

8. A computer-readable storage medium storing a vehicle driving assistance program which executes an intermittent driving control of driving a host vehicle by autonomously and alternately executing a propelling control of propelling the host vehicle and a coasting control of causing the host vehicle to coast,
wherein a driving apparatus which generates mechanical power and a battery which stores electric power are mounted on the host vehicle,
the driving apparatus includes an internal combustion engine and a motor generator,
the motor generator operates by electric power supplied from the battery to generate mechanical power and also operates by mechanical power generated by the internal combustion engine to generate electric power,
electric power generated by the motor generator is stored in the battery,
the propelling control is a control of propelling the host vehicle by mechanical power generated by the internal combustion engine and/or the motor generator,
the vehicle driving assistance program is configured not to execute the intermittent driving control when a prohibition condition is satisfied in a situation where execution of the intermittent driving control is requested, and
the prohibition condition is satisfied when at least one of the following is satisfied:
a first condition that an amount of electric power stored in the battery is equal to or smaller than a predetermined prohibition stored electric amount;
a second condition that a consumption rate of electric power stored in the battery is equal to or greater than a predetermined prohibition consumption rate;
a third condition that a traveling speed of the host vehicle is equal to or smaller than a predetermined prohibition speed;
a fourth condition that a following vehicle cannot be detected; and
a fifth condition that the driving apparatus is operated in an operation mode in which an electric drive traveling state in which only mechanical power generated by the motor generator is used without using mechanical power generated by the internal combustion engine as mechanical power for driving the host vehicle occurs.
